(19) United States
(12) Patent Application Publication
(10) Pub. No.: US 2009/0151466 A1
(43) Pub. Date: Jun. 18, 2009

(54) FIXING ELEMENT AND INSPECTION SYSTEM THEREOF

(75) Inventors: TUNG-CHUAN WU, Hsinchu City (TW); SHUO-HUNG CHANG, Taipei County (TW); LAI-SHENG CHEN CHEN, Hsinchu City (TW); YEN-CHIEH MAO, Kaohsiung City (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, HSIN-CHU (TW)

(21) Appl. No.: 12/053,390

(22) Filed: Mar. 21, 2008

(30) Foreign Application Priority Data
Dec. 13, 2007 (TW) 096147694

(51) Int. Cl. G01L 1/20; F16B 31/02

(52) U.S. Cl. 73/761; 411/14; 411/10

(57) ABSTRACT

A fixing element and inspection system for examining the status of the fixing element are provided in the present invention. The fixing has a sensing material disposed therein for transforming the force acting on the fixing element into an electrical signal. A signal processing unit, powered by a radio frequency circuit, is coupled to the sensing material for transforming the electrical signal into a readable signal and then transmitting the readable signal to the inspection system through radio frequency so as to monitor the status of the fixing element. By means of the present invention, it is capable of inspecting and monitoring the status of a great amount of fixing elements rapidly and precisely, especially in occasion that extreme safety should be highly concerned, for example, fixing elements secured to the airplane.

### FIELD OF THE INVENTION

The present invention relates to method for inspecting fixing statuses of fixing elements, and more particularly, to a fixing element configured with a sensing material capable of sensing a force acting on the fixing element while converting the force into an electrical signal.

### BACKGROUND OF THE INVENTION

Fixing elements can be considered as the foundation of all industrial products, which are used in products from as small as a toy to large-sized industrial equipments, such as nautical equipments or flight vehicles. Especially for those flight vehicles, it will take only one loosened fixing element to cause immediate and severe risk to flight safety that severely endangers the lives and properties of the passenger onboard the flight vehicles. In Aug. 28, 2008, Federal Aviation Administration (FAA) of United State rarely issued an emergency airworthiness directive (EAD) again for requiring all airliners to perform the inspection on the nut and bolt in the downstop assembly for the slat track on all the Next Generation Boeing 737 aircraft within 10 days instead of 24 days, since in the inspection required by the previous emergency airworthiness directive (EAD) issued also by FAA immediately after the burning and explosion of a China Airlines' Boeing 737-800 in Naha airport, Okinawa. Japan, there are at least twenty-three Boeing 737s being identified to suffer the same problem of having a loose bolt from the wing slat assembly while one of which had a hole in it's wing fuel tank.

Conventionally, the inspection of loosen bolt is performed by the detection of pneumatic pressure, torque or vibration. In U.S. Pub. No. 20070172330 and U.S. Pat. No. 4,636,121, the disclosed screw loosening prevention structure is able to detect the status of a fixing element, such as a bolt, by the use of a pneumatic or hydraulic means. In U.S. Pat. Nos. 5,410,206 and 5,476,014, the status of a fixing element is detected by the use of a torque detection device. In addition, in U.S. Pub. No. 20070238992, the status of a fixing element is detected by the use of a vibration detection device.

General speaking, there are multiple precautionary safety measures being taken for preventing all the screws used for fixing important parts of flight vehicles from loosening. One of which is implemented by tightening a steel wire on the screw following the direct opposite to the fastening direction of the same. In addition, all the screw on flight vehicles must by tighten by torque wrenches while marking each with an alignment mark for facilitating inspectors to determine whether the screw is loosened by naked eye. However, all the above precautionary safety measures can only be taken for those parts capable of being seen on maintenance by naked eye. For those embedded inside the interior of the flight vehicles' structure, any loosen parts due to design fault or other factors can not be detected in general inspection programs unless a special inspection is taken for tearing the flight vehicle apart. Any loosened part of an aircraft is going to severe endanger the lives of passengers onboard the aircraft.

### SUMMARY OF THE INVENTION

The object of the present invention is to provide a fixing element configured with a sensing material capable of sensing a force acting on the fixing element while converting the force into an electrical signal to be transmitted by the use of a communication circuit embedded in the fixing element.

Another object of the invention is to provide an inspection system capable of utilizing an electrical signal issued from a sensing material embedded inside a fixing element to perform an analysis for determining the stress status of the fixing element and thus capable of being used for inspecting fixing elements in a massive and accurate manner.

In an exemplary embodiment of the invention, the present invention provides a fixing element, comprising: a frame, having a sensing material configured therein for sensing a force acting on the frame so as to generate an electrical signal accordingly; a signal transformation circuit, arranged at a side of the frame while electrically coupled to the sensing material for enabling the same to transform the electrical signal into a transformation signal; and a radio frequency circuit, electrically coupled to the signal transformation circuit for transmitting the transformation signal.

In another exemplary embodiment of the invention, the present invention provides an fixing element inspection system, comprising: a fixing element, further comprising: a frame, having a sensing material configured therein for sensing a force acting on the frame so as to generate an electrical signal accordingly; a signal transformation circuit, arranged at a side of the frame while electrically coupled to the sensing material for enabling the same to transform the electrical signal into a transformation signal; and a radio frequency circuit, electrically coupled to the signal transformation circuit for transmitting the transformation signal; an interrogation device, capable of communicating with the radio frequency circuit in a manner that it is able to transmit/receive signal to/from the radio frequency circuit; and a signal analysis device, coupled to the interrogation device for processing and analyzing signals received by the interrogation device so as to determine the status of the fixing element.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A is a sectional view of a fixing element according to a first embodiment of the invention.

FIG. 1B is a schematic view of a signal processing unit configured in the fixing element of the present invention

FIG. 2 is a schematic view of a fixing element according to a second embodiment of the invention.

FIG. 3 is a schematic view of a fixing element according to a third embodiment of the invention.

FIG. 4 is a schematic view of a fixing element according to a fourth embodiment of the invention.

FIG. 5 is a schematic view of a fixing element according to a fifth embodiment of the invention.

FIG. 6 shows a fixing element inspection system of the invention.

FIG. 7 is a block diagram depicting fixing element inspection system of the invention.

FIG. 8 is a timing diagram illustrating the magnitude variation of an electrical signal detected from a normal fixing element.

FIG. 9 is a timing diagram illustrating an electrical signal with abnormal decaying detected from an abnormal fixing element.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

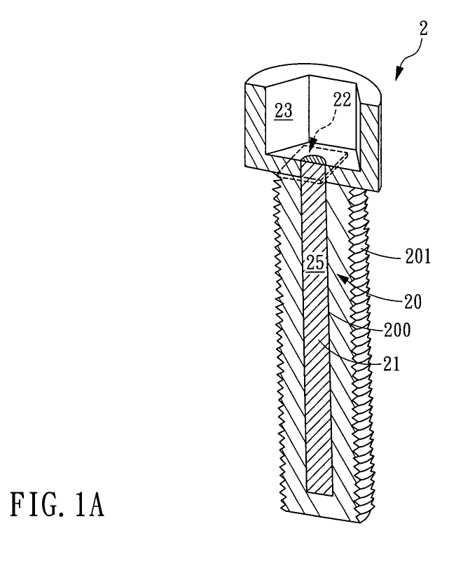

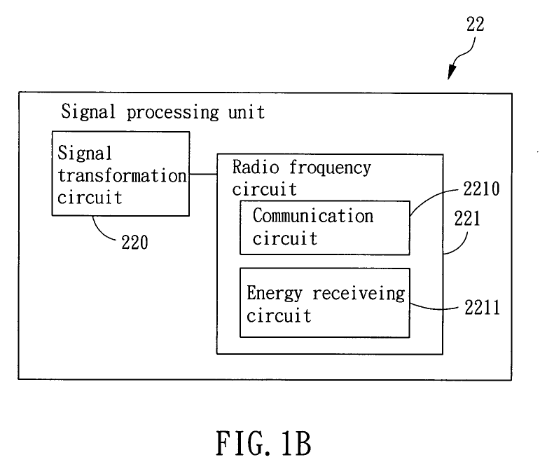

Please refer to FIG. 1A and FIG. 1B, which are a sectional view of a fixing element according to a first embodiment of the invention and a schematic view of a signal processing unit configured in the fixing element. In this embodiment, the fixing element 2 is substantially an inner hexagon screw comprising a frame 20. As seen in FIG. 1A, there is an accommodation space 25 formed inside the frame 20, which is used for receiving a sensing material 21. It is noted that the accommodation space is basically a hollow structure 200 formed inside the frame 20, which can be composed of via holes, grooves or concaves as required. In addition, glue can be fixed at the interface between the sensing material 21 and the hollow structure 200, by which the sensing material 21 can be securely fixed inside the hollow structure 200. In this embodiment, the follow structure 200 is disposed inside the frame 20 at a position corresponding to the thread of the screw 2. The sensing material 21 can be an electro-sensitive material selected from a piezoelectric material and an electrostrictive material, which is able to sense the variations of forces for generating electrical signals, such as voltage signals or current signals.

Moreover, in this embodiment, there is a signal processing unit 22 being received inside the inner hexagon hole 23 of the frame 20, which comprises a signal transformation circuit 220 and a radio frequency (RF) circuit 221. The signal transformation circuit 220 is electrically coupled to the sensing material 21 for enabling the same to transform the electrical signal into a transformation signal. In addition the transformation signal can be a digital signal or an analog signal, which is dependent upon the transformation characteristic of the signal transformation circuit 220. The RF circuit 221 is electrically coupled to the signal transformation circuit 220 for transmitting the transformation signal out of the fixing element 2 as well as receiving interrogation signals form ambient environment.

Furthermore, the RF circuit 221 is further comprised of a communication circuit 2210 and an energy receiving circuit 2211, in which the communication circuit 2210 is electrically coupled to the signal transformation circuit 220 for transmitting the transformation signal as well as an identification code of the fixing element 2 corresponding to the transformation signal; and the energy receiving circuit 2211 is electrically coupled to the signal transformation circuit 220 and the communication circuit 2210 for receiving a radio frequency (RF) signal while converting the received RF signal into electrical energy to be used for powering the signal transformation circuit 220 and the communication circuit 2210. In this embodiment, the radio frequency circuit 221 can be a passive radio frequency identification (RFID) device.

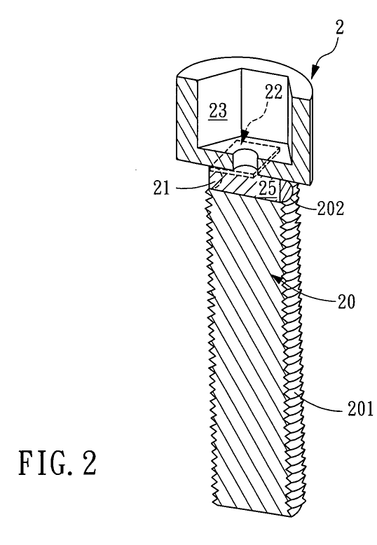

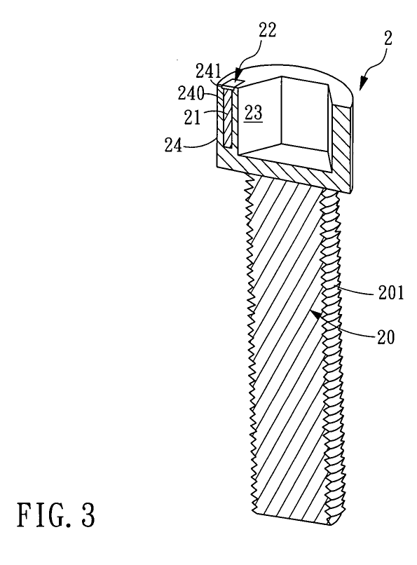

Please refer to FIG. 2, which is a schematic view of a fixing element according to a second embodiment of the invention. In this second embodiment, the fixing element 2 is also an inner hexagon screw that is different from the one shown in the first embodiment by having a via hole 202 formed at the interface position between the inner hexagon hole 23 and the threaded portion of the screw 2 while having the accommodation space 25 to be formed inside the via hole 202 for receiving the sensing material 21. Similarly, the signal processing unit 22 is disposed inside the inner hexagon hole 23 of the frame 20. Please refer to FIG. 3, which is a schematic view of a fixing element according to a third embodiment of the invention. In the third embodiment, the side wall 24 surrounding the inner hexagon hole 23 is bored to form a hole 240, which can be used for receiving the sensing material 21. In addition, the signal processing unit 22 can be disposed at the side wall 24 in a manner that the signal processing unit 22 is inset into a concave 241 formed on the side wall 24 while being electrically connected to the sensing material 21 for enabling the same to receiving the electrical signal from the sensing material 21 and then transforming the received electrical signal for transmitting.

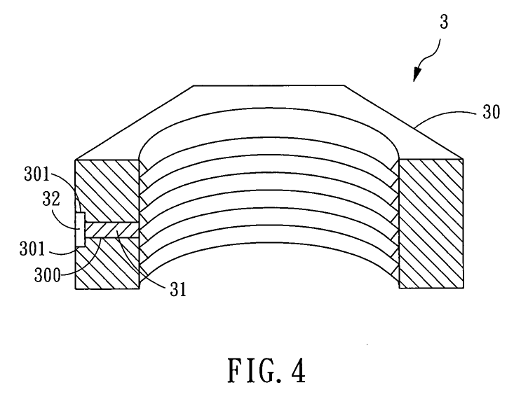

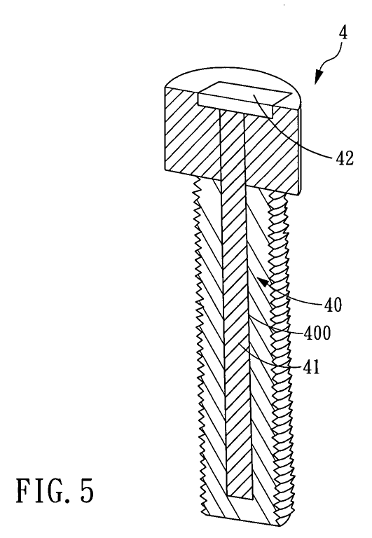

Please refer to FIG. 4, which is a schematic view of a fixing element according to a fourth embodiment of the invention. In the fourth embodiment, the fixing element 3 is a nut whose frame 30 is configured with a via hole 300 for receiving a sensing material 31. It is noted that the characteristics of the sensing material 31 is the same as that described in FIG. 1A and thus are not elaborated further herein. In addition, there is a concave 301 formed on a side wall of the frame 30, which is used for receiving a signal processing unit 32 while enabling the same to electrically connected to the sensing material 31. Similarly, the characteristics of the signal processing unit 32 is the same as that described in FIG. 1B and thus are not elaborated further herein. Please refer to FIG. 5, which is a schematic view of a fixing element according to a fifth embodiment of the invention. In the fifth embodiment, the fixing element 4 is a bolt whose frame 40 is configured with a hollow structure 400 for receiving a sensing material 41. In addition, a signal sensing unit 42 can be arranged by attaching the same to an end of the sensing material 41. It is noted that both the sensing material 41 and the signal processing unit 42 are operating according to the same principle as mentioned above and thus will not be elaborated further herein. It is noted that other than those mentioned in the foregoing embodiments, there can be other fixing elements, such as Philip's head screw or slotted screw, capable of being configured for achieving the same objects according to the present invention.

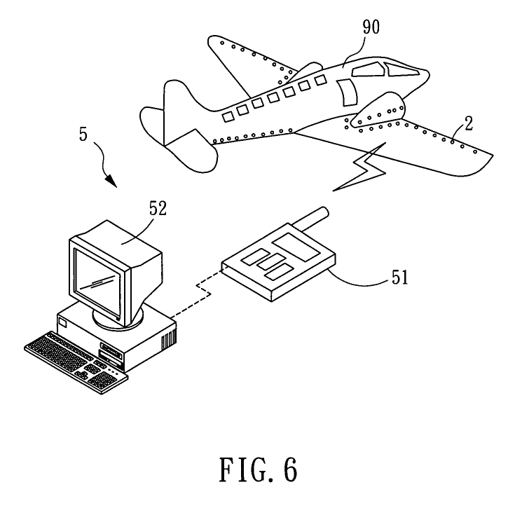

Please refer to FIG. 6, which shows a fixing element inspection system of the invention. In FIG. 6, the fixing element inspection system 5 comprises at least a fixing element 2, an interrogation device 51 and a signal analysis device 52. each fixing element 2 is mounted on a vehicle which can be any instrument, apparatus or system to be used as holding component. In this embodiment, an aircraft 90 is used as the vehicle for illustration. Thus, there can be a plurality of such fixing elements 2 used in the aircraft 90 for securing and holding parts of the aircraft 90 together and each of the plural fixing elements can be the one selected from the above mentioned embodiments.

The interrogation device 51 is enabled to communicate with each fixing element 2 in a manner that it is able to transmit/receive signal to/from the fixing element 2. In this embodiment, the interrogation device 51 can be a radio frequency identification (RFID) device or other wireless receiver. The signal analysis device 52 is coupled to the interrogation device 51 for processing and analyzing signals received by the interrogation device 51 so as to determine the status of the fixing element 2. The connection between the signal analysis device 52 and the interrogation device 51 can be realized by the use of a wired means or a wireless means. It is noted that the signal analysis device 52 can be a computer or a workstation whichever is equipped with computation ability, but is not limited thereby. Moreover, the signal analysis device 52 can further comprises a recording unit 520 and an analyzing unit 521. The recording unit 520 is used for storing signals received by the interrogation device 51; and the analyzing unit 521 is used for analyzing data stored in the recording unit 520 and performing a statistic analysis relating to the status of each fixing element 2.

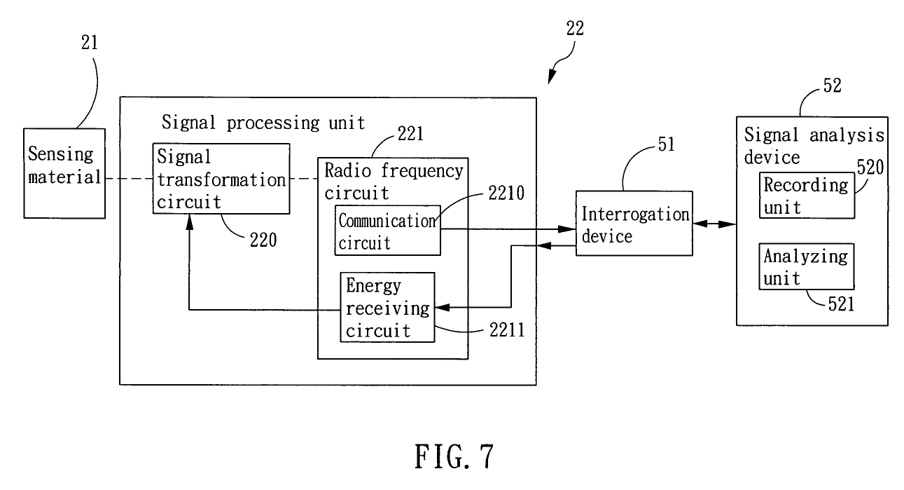

Please refer to FIG. 7, is a block diagram depicting fixing element inspection system of the invention. For securely fixing each fixing element 2 on the shell of the aircraft 90, each fixing element 2 must be tightened properly by the use of a wrench or a screw driver. However, as the sensing material is made of a piezoelectric material or an electrostrictive material, it can detect tensions caused when the frame of the fixing element is stressed and thus generate an electrical signal such as a voltage signal or a current signal. Therefore, when an user direct the interrogation device 51 to issue an interrogation signal, the energy receiving circuit 2211 of the RF circuit 221 will receive the interrogation signal while converting the same for powering signal transmission and processing. Moreover, as soon as the interrogation signal is received by the signal processing unit 22, the signal transformation circuit 220 will be activated to received an electrical signal issued from the sensing material 21 while converting the same into a digital or analog transformation signal, which is then being transmitted back to the interrogation device 51 by the communication circuit 2210.

As soon the transformation signal is received by the interrogation device 51, it will be send to the signal analysis device 52 by a wireless means or a wireless means. Thereafter, the recording unit 520 of the signal analysis device 52 will first store the received signal into a storage media, and then the analyzing unit 521 will be able to perform an analysis upon the received signal for determine the fixing status of the fixing element. If a fixing element 2 is tightened properly, the sensing material 21 is subjecting to a specific tension which is considered to be proper and thus issues a specific electrical signal to be transformed into a specific transformation signal. Such specific transformation signal will be detected by an interrogation device 51 as soon as the interrogation device is in the neighborhood of the fixing element 2 so that the user can be informed that the fixing element 2 is tightened properly. On the other hand, if a fixing element 2 is loosened or cracked, the sensing material 21 is subjecting to an abnormal tension or even no tension which is going to cause the electrical signal to weaken or disappear, so that when the interrogation device 51 is in the neighborhood of the fixing element 2, it can detect that the abnormal fixing element 2. From the above description, the inspection system 5 can be being used for inspecting fixing elements in a massive and accurate manner as it is capable of utilizing an electrical signal issued from a sensing material embedded inside a fixing element to perform an analysis for determining the stress status of the fixing element. Moreover, such inspection system is especially suitable for occasions of high safety precautions, such as for inspecting screws of aircrafts.

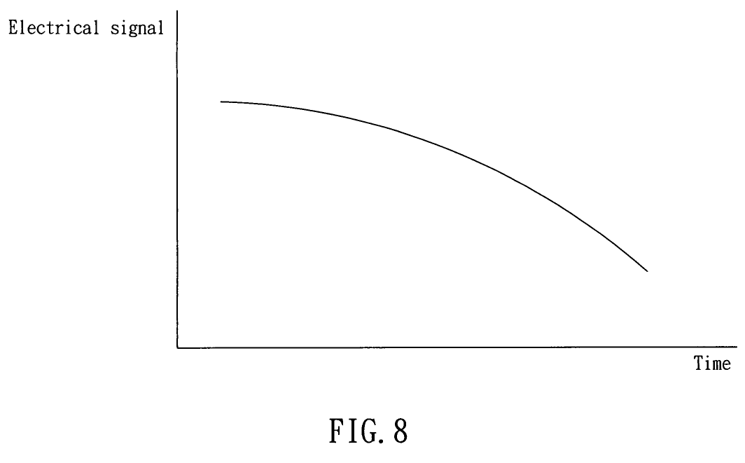

In addition, since the electrical signal generated by the sensing material at the same stressed condition is varying with time, there can be a variety of calibration methods to be taken by a user for calibrating the analyzing unit so that the fixing status of the fixing element can be analyzed correctly. One calibration method is that: as soon as a batch of fixing elements is produced, a calibration curve is generated specifically for the batch in a manner that by subjecting the fixing element to a specific tightening force, the electrical signal variations generated from the sensing material through time are charted into the calibration curve, as the one shown in FIG. 8. Thus, by referencing to the calibration curve on the spot of detection, it is possible to determine the magnitude of the tightening force acting on the fixing element.

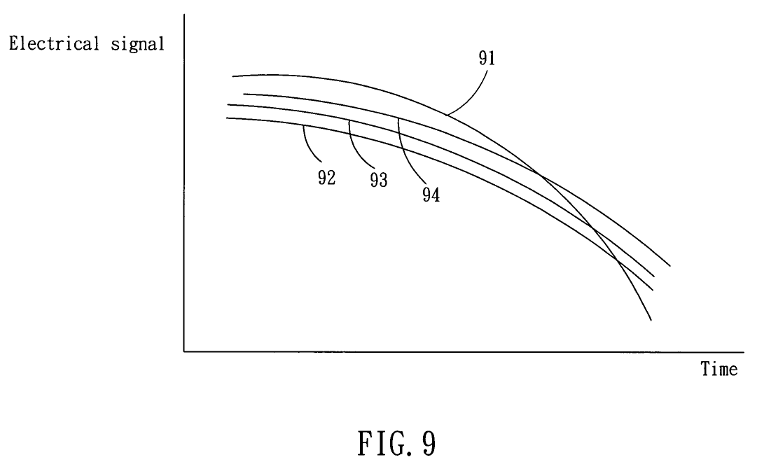

Another method is performed by the use of the electrical signal magnitude detected on the spot of detection without referencing to the previous-established calibration curve. As seen in FIG. 9, under the summation that the signal decaying trend of every fixing element of the same batch that is tightened properly will be the same, any abnormal fixing element can be detected when it decaying trend is abnormal. Since each fixing element is marked by its specific identification code, the signal analysis device is able to chart various curves in correspondence to different codes, which are exemplified as the curves 91, 92, 93 and 94 shown in FIG. 9. In FIG. 9, as the curve 91 stands out above the other curves 92, 93, 94, one can concluded that the fixing element corresponding to the curve 91 is abnormal. It is noted that the curves shown in FIG. 8 and FIG. 9 are only for illustration that the actual curves are dependent upon the actual sensing material used.

To sum up, the present invention provides a fixing element and an inspection system for the same that is capable of utilizing an electrical signal issued from a sensing material embedded inside a fixing element to perform an analysis for determining the stress status of the fixing element and thus capable of being used for inspecting fixing elements in a massive and accurate manner, so that it is especially suitable for occasions of high safety precautions.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A fixing element, comprising:
a frame, having a sensing material configured therein for sensing a force acting on the frame so as to generate an electrical signal accordingly; and
a signal processing unit, electrically coupled to the sensing material, further comprising:
a signal transformation circuit, arranged at a side of the frame while electrically coupled to the sensing material for enabling the same to transform the electrical signal into a transformation signal; and
a radio frequency circuit, electrically coupled to the signal transformation circuit for transmitting the transformation signal.

2. The fixing element of claim 1, wherein the frame is an element selected from the group consisting of a nut, bolt and a screw.

3. The fixing element of claim 1, wherein the transformation signal is a signal selected from a digital signal and an analog signal.

4. The fixing element of claim 1, wherein the radio frequency circuit further comprises:
a communication circuit, electrically coupled to the signal transformation circuit for transmitting the transformation signal as well as an identification code of the fixing element corresponding to the transformation signal; and
an energy receiving circuit, electrically coupled to the signal transformation circuit and the communication circuit, being used for receiving a radio frequency (RF) signal while converting the received RF signal into electrical energy for powering the signal transformation circuit and the communication circuit.

5. The fixing element of claim 1, wherein the radio frequency circuit is a passive radio frequency identification (RFID) device.

6. The fixing element of claim 1, wherein the sensing material is an electro-sensitive material selected from a piezoelectric material and an electrostrictive material.

7. The fixing element of claim 1, wherein there is an accommodation space formed in the frame for receiving the sensing material.

8. The fixing element of claim 7, wherein the sensing material is securely fixed inside the accommodation space by gluing.

9. A fixing element inspection system, comprising:
a fixing element, further comprising:
a frame, having a sensing material configured therein for sensing a force acting on the frame so as to generate an electrical signal accordingly; and
a signal processing unit, further comprising:
a signal transformation circuit, arranged at a side of the frame while electrically coupled to the sensing material for enabling the same to transform the electrical signal into a transformation signal; and
a radio frequency circuit, electrically coupled to the signal transformation circuit for transmitting the transformation signal;
an interrogation device, capable of communicating with the radio frequency circuit in a manner that it is able to transmit/receive signal to/from the radio frequency circuit; and
a signal analysis device, coupled to the interrogation device for processing and analyzing signals received by the interrogation device so as to determine the status of the fixing element.

10. The inspection system of claim 9, wherein the frame is an element selected from the group consisting of a nut, bolt and a screw.

11. The inspection system of claim 9, wherein the transformation signal is a signal selected from a digital signal and an analog signal.

12. The inspection system of claim 9, wherein the radio frequency circuit further comprises:
a communication circuit, electrically coupled to the signal transformation circuit for transmitting the transformation signal as well as an identification code of the fixing element corresponding to the transformation signal; and
an energy receiving circuit, electrically coupled to the signal transformation circuit and the communication circuit, being used for receiving a radio frequency (RF) signal while converting the received RF signal into electrical energy for powering the signal transformation circuit and the communication circuit.

13. The inspection system of claim 9, wherein the radio frequency circuit is a passive radio frequency identification device.

14. The inspection system of claim 9, wherein the sensing material is an electro-sensitive material selected from a piezoelectric material and an electrostrictive material.

15. The inspection system of claim 9, wherein there is an accommodation space formed in the frame for receiving the sensing material.

16. The inspection system of claim 15, wherein the sensing material is securely fixed inside the accommodation space by gluing.

17. The inspection system of claim 15, wherein the signal analysis device further comprises:
a recording unit, for storing signals received by the interrogation device; and
an analyzing unit, for analyzing data stored in the recording unit and performing a statistic analysis relating to the status of the fixing element.
